(19) United States
(12) Patent Application Publication
(10) Pub. No.: US 2026/0002075 A1
(43) Pub. Date: Jan. 1, 2026

(54) TREATMENT LIQUID AND TREATMENT METHOD

(71) Applicant: FUJIFILM CORPORATION, Tokyo (JP)

(72) Inventors: Kazutaka Takahashi, Shizuoka (JP); Akihiko Ohtsu, Shizuoka (JP); Tomonori Takahashi, Shizuoka (JP)

(21) Appl. No.: 19/320,575

(22) Filed: Sep. 5, 2025

Related U.S. Application Data
(63) Continuation of application No. PCT/JP2024/007141, filed on Feb. 27, 2024.

(30) Foreign Application Priority Data
Mar. 24, 2023 (JP) 2023-048426

(51) Int. Cl. C09K 13/08

(52) U.S. Cl. CPC C09K 13/08

(57) ABSTRACT

An object of the present invention is to provide a treatment liquid which, in a case of being applied to an object to be treated containing a silicon-germanium-containing substance and a silicon-containing substance, selectively dissolves the silicon-germanium-containing substance and suppresses a variation in a dissolution rate between a central portion and an end portion in the silicon-germanium-containing substance. The treatment liquid of the present invention is a treatment liquid used for an object to be treated, which contains a silicon-germanium-containing substance and a silicon-containing substance, to remove at least a part of the silicon-germanium-containing substance, the treatment liquid containing a fluoride ion source, an organic acid, an oxidant, a solvent having a relative permittivity of 10 or less, and water, in which a content of the water is more than 0% by mass and less than 30% by mass with respect to the total mass of the treatment liquid.

### CROSS-REFERENCE TO RELATED APPLICATIONS

This application is a Continuation of PCT International Application No. PCT/JP2024/007141 filed on Feb. 27, 2024, which claims priority under 35 U.S.C. § 119(a) to Japanese Patent Application No. 2023-048426 filed on Mar. 24, 2023. The above applications are hereby expressly incorporated by reference, in their entirety, into the present application.

### BACKGROUND OF THE INVENTION

### 1. Field of the Invention

The present invention relates to a treatment liquid and a treatment method.

More specifically, the present invention relates to a treatment liquid which is used for an object to be treated having a silicon-germanium-containing substance and a silicon-containing substance to remove at least a part of the silicon-germanium-containing substance. The present invention also relates to a treatment method using the treatment liquid.

### 2. Description of the Related Art

In a case of forming circuits and elements, it is common to carry out an etching process using a chemical liquid. In this case, since a plurality of materials may be present on a substrate, it is desirable that the chemical liquid used for the etching is capable of selectively removing only a specific material.

For example, JP2019-165218A discloses an etching solution (treatment liquid) suitable for selectively removing a silicon-germanium-containing substance rather than a germanium-containing substance from a microelectronics device. Specifically, an etching solution (treatment liquid) containing water, an oxidant, a water-miscible organic solvent, a fluoride ion source, a corrosion inhibitor, and a buffer member is disclosed.

### SUMMARY OF THE INVENTION

Depending on the use, it may be required to remove at least a part of a silicon-germanium-containing substance (hereinafter, also referred to as “Si—Ge-containing substance”) and a silicon-containing substance (hereinafter, also referred to as “Si-containing substance”) from an object to be treated.

The present inventors applied the treatment liquid (etching solution) disclosed in JP2019-165218A to the above-described object to be treated, and found that, in the Si—Ge-containing substance, variation in a dissolved state occurs between a central portion and an end portion. In the Si—Ge-containing substance, in a case where there is a variation in a dissolution rate between the central portion and the end portion as described above, a desired shape may not be formed, and thus improvement has been required.

Therefore, an object of the present invention is to provide a treatment liquid which, in a case of being applied to an object to be treated containing an Si—Ge-containing substance and an Si-containing substance, selectively dissolves the Si—Ge-containing substance and suppresses a variation in a dissolution rate between a central portion and an end portion in the Si—Ge-containing substance.

Another object of the present invention is to provide a treatment method using the above-described treatment liquid.

The present inventors have completed the present invention as a result of intensive studies to solve the above-described problems. That is, the present inventors have found that the above-described objects can be achieved by the following configuration.
[1] A treatment liquid used for an object to be treated, which contains a silicon-germanium-containing substance and a silicon-containing substance, to remove at least a part of the silicon-germanium-containing substance, the treatment liquid comprising:
a fluoride ion source;
an organic acid;
an oxidant;
a solvent having a relative permittivity of 10 or less; and
water,
in which a content of the water is more than 0% by mass and less than 30% by mass with respect to a total mass of the treatment liquid.
[2] A treatment liquid used for an object to be treated, which contains a silicon-germanium-containing substance and a silicon-containing substance, to remove at least a part of the silicon-germanium-containing substance, the treatment liquid comprising:
a fluoride ion source;
an organic acid; and
an oxidant,
in which a relative permittivity of the treatment liquid is 30.0 or less,
where the relative permittivity is a value obtained by calculating a value by multiplying a relative permittivity of a single substance of each component contained in the treatment liquid by a volume-based content proportion of each component, and summing the calculated values, provided that a single substance of each component, having a volume-based content proportion of 0.1% by volume or less, is assumed to have a relative permittivity of 0.
[3] The treatment liquid according to [2], further comprising:
a solvent having a relative permittivity of 10 or less; and
water,
in which a content of the water is more than 0% by mass and less than 30% by mass with respect to a total mass of the treatment liquid.
[4] The treatment liquid according to [1] or [3],
in which the content of the water is 1.0% to 15.0% by mass with respect to the total mass of the treatment liquid.
[5] The treatment liquid according to [1], [3], or [4],
in which a content of the solvent having a relative permittivity of 10 or less is 3.0% by mass or more with respect to the total mass of the treatment liquid.
[6] The treatment liquid according to any one of [1] and [3] to [5],
in which a mass ratio of the content of the water to a content of the solvent having a relative permittivity of 10 or less is 1 to 10.
[7] The treatment liquid according to any one of [1] and [3] to [6],
in which an SP value of the solvent having a relative permittivity of 10 or less is 18 MPa^{1/2} or more.
[8] The treatment liquid according to any one of [1] and [3] to [7],
in which the solvent having a relative permittivity of 10 or less includes one or more selected from the group consisting of benzyl benzoate, methyl benzoate, 1,2,4-trichlorobenzene, o-dichlorobenzene, bromobenzene, methyl formate, diethyl oxalate, ethyl propionate, ethyl benzoate, dioxane, chlorobenzene, ethyl formate, tetrahydrofuran, phenetole, methyl acetate, ethyl bromide, benzene, m-xylene, toluene, ethyl acetate, methyl tetrahydrofuran, p-xylene, o-xylene, and pentyl acetate.
[9] The treatment liquid according to any one of [1] and [3] to [8],
in which the treatment liquid contains two or more kinds of the solvents having a relative permittivity of 10 or less.
[10] The treatment liquid according to any one of [1] to [9],
in which the organic acid includes one or more selected from the group consisting of formic acid, acetic acid, propionic acid, and butyric acid.
[11] The treatment liquid according to any one of [1] to [10], further comprising:
an amine compound represented by Formula (I) described later.
[12] A treatment method comprising:
bringing an object to be treated, which contains a silicon-germanium-containing substance and a silicon-containing substance, into contact with the treatment liquid according to any one of [1] to [11] to remove at least a part of the silicon-germanium-containing substance.

According to the present invention, it is possible to provide a treatment liquid which, in a case of being applied to an object to be treated containing an Si—Ge-containing substance and an Si-containing substance, selectively dissolves the Si—Ge-containing substance and suppresses a variation in a dissolution rate between a central portion and an end portion in the Si—Ge-containing substance.

In addition, according to the present invention, it is also possible to provide a treatment method using the above-described treatment liquid.

### BRIEF DESCRIPTION OF THE DRAWINGS

FIG. 1 is a schematic view of a cross-sectional observation image for describing a method of evaluating rectangularity in Examples.

### DESCRIPTION OF THE PREFERRED EMBODIMENTS

Hereinafter, the present invention will be described in detail.

The description of the configuration requirements described below is made on the basis of representative embodiments of the present invention, but it should not be construed that the present invention is limited to those embodiments.

Hereinafter, meaning of each description in the present specification will be explained.

In the present specification, a numerical range represented by “to” means a range including numerical values before and after “to” as a lower limit value and an upper limit value.

In the present specification, “ppm” is an abbreviation for “parts per million” and means 10⁻⁶. In addition, “ppb” is an abbreviation for “parts per billion” and means 10⁻⁹. “ppt” is an abbreviation for “parts per trillion” and means 10⁻¹².

In the present specification, in a case where there are two or more components corresponding to a certain component, “content” of such a component means the total content of the two or more components.

In the present specification, “silicon-germanium-containing substance (Si—Ge-containing substance)” refers to a material containing an Si element and a Ge element, and a material substantially composed of only an Si element and a Ge element is preferable. The “substantially” means that the total content of the Si element and the Ge element is 95 atom % or more with respect to all atoms of the material. Therefore, in the material substantially composed of only the Si element and the Ge element, other elements may be contained as long as the total content of the Si element and the Ge element is within the above-described range. In addition, in the Si—Ge-containing substance, a content ratio of the Si element and the Ge element is not particularly limited, and a proportion of the content of the Ge element to the total amount of the Si element and the Ge element is preferably 1 to 70 atom %.

In addition, in the present specification, “silicon-containing substance (Si-containing substance)” refers to a material containing an Si element, and a material substantially composed of only an Si element is preferable. The “substantially” means that a content of the Si element is 95 atom % or more with respect to all atoms of the material. Therefore, in the material substantially composed of only the Si element, other elements (excluding the Ge element) may be contained as long as the content of the Si element is within the above-described range.

Unless otherwise specified, “exposure” includes exposure with a mercury lamp, a far ultraviolet ray represented by an excimer laser, an X-ray, or EUV light, and drawing with a corpuscular beam such as an electron beam and an ion beam.

“Preparation” includes not only providing a specific material by synthesis, formulation, or the like, but also procuring a predetermined item by purchase or the like.

With regard to a bonding direction of a divalent group (for example, —COO—), unless otherwise specified, in a case where Y in a compound represented by “X-Y-Z” is —COO—, the compound may be “X—O—CO—Z” or “X—CO—O—Z”.

Hereinafter, the treatment liquid according to the embodiment of the present invention will be described. Examples of the treatment liquid according to the embodiment of the present invention include a treatment liquid according to a first embodiment and a treatment liquid according to a second embodiment, which will be described below.

The treatment liquid according to the first embodiment of the present invention is a treatment liquid used for an object to be treated, which contains an Si—Ge-containing substance and an Si-containing substance, to remove at least a part of the Si—Ge-containing substance, the treatment liquid containing a fluoride ion source, an organic acid, an oxidant, a solvent having a relative permittivity of 10 or less, and water, in which a content of the water is more than 0% by mass and less than 30% by mass with respect to the total mass of the treatment liquid.

The treatment liquid according to the second embodiment of the present invention is a treatment liquid used for an object to be treated, which contains an Si—Ge-containing substance and an Si-containing substance, to remove at least a part of the Si—Ge-containing substance, the treatment liquid containing a fluoride ion source, an organic acid, and an oxidant, in which a relative permittivity of the treatment liquid is 30 or less. A method for calculating the relative permittivity of the treatment liquid will be described later.

In a case where the treatment liquid according to the embodiment (the first embodiment and the second embodiment) of the present invention is used for an object to be treated (hereinafter, also simply referred to as “object to be treated”) containing an Si—Ge-containing substance and an Si-containing substance, the Si—Ge-containing substance is selectively dissolved, and variation in a dissolution rate between a central portion and an end portion in the Si—Ge-containing substance is suppressed. In a case where the treatment liquid according to the embodiment of the present invention is used, the mechanism by which the Si—Ge-containing substance is selectively dissolved in the object to be treated and the variation in the dissolution rate between the central portion and the end portion in the Si—Ge-containing substance is suppressed is not necessarily clear, but the present inventors have presumed as follows.

Since the treatment liquid according to the first embodiment of the present invention contains the organic acid and the oxidant, surfaces of the Si—Ge-containing substance and the Si-containing substance are oxidized. It is considered that, in a case of comparing oxides formed on the surfaces thereof, the oxide formed on the surface of the Si—Ge-containing substance is more easily soluble than the oxide formed on the surface of the Si—Ge-containing substance. The treatment liquid according to the first embodiment further contains the fluoride ion source, and it is considered that, since ions generated from the fluoride ion source promote dissolution of the Si—Ge-containing substance, the treatment liquid selectively dissolves the Si—Ge-containing substance.

In addition, since the treatment liquid according to the first embodiment contains the solvent having a relative permittivity of 10 or less and the water, and the content of the water is more than 0% by mass and less than 30% by mass with respect to the total mass of the treatment liquid, a relative permittivity of the entire treatment liquid is likely to be low. In this case, even in a case where there is a difference in chargeability between the Si—Ge-containing substance and a member in contact with the Si—Ge-containing substance in the object to be treated, the Si—Ge-containing substance and the member in contact with the Si—Ge-containing substance are less likely to be charged, and a difference in amount of charge to be generated is also likely to be small. It is considered that, in the Si—Ge-containing substance, since the dissolution is promoted by the supply of ions generated from the fluoride ion source to the surface of the Si—Ge-containing substance, in a case where there is a bias in the supply amount, there is a variation in the dissolution rate of the Si—Ge-containing substance. Here, since the ions generated from the fluoride ion source are charged, in a case where the difference in the amount of charge to be generated is small as described above, the ions are easily uniformly supplied to the surface of the Si—Ge-containing substance; and as a result, it is considered that the dissolution rate between the central portion and the end portion in the Si—Ge-containing substance is likely to be uniform.

Since the treatment liquid according to the second embodiment of the present invention contains the fluoride ion source, the organic acid, and the oxidant, it is considered that the treatment liquid selectively dissolves the Si—Ge-containing substance based on the same principle as the treatment liquid according to the first embodiment of the present invention described above.

In addition, in the treatment liquid according to the second embodiment, the relative permittivity of the treatment liquid is 30 or less. In this case, it is considered that, based on the same principle as the treatment liquid according to the first embodiment of the present invention described above, the Si—Ge-containing substance and the member in contact with the Si—Ge-containing substance are less likely to be charged, and ions generated from the fluoride ion source are easily supplied uniformly to the surface of the Si—Ge-containing substance. As a result, it is considered that the dissolution rate between the central portion and the end portion in the Si—Ge-containing substance is likely to be uniform even in the treatment liquid according to the second embodiment.

Hereinafter, the treatment liquid according to the embodiment (the first embodiment and the second embodiment) of the present invention will be described.

Hereinafter, in a case of being applied to an object to be treated, the fact that the Si—Ge-containing substance is more selectively dissolved is also referred to as “Si—Ge dissolution selectivity is more excellent”. In addition, in a case of being applied to the object to be treated, the fact that the variation in the dissolution rate between the central portion and the end portion in the Si—Ge-containing substance is further suppressed is also simply referred to as “dissolution variation can be further suppressed”.

### Treatment Liquid (First Embodiment)

The treatment liquid according to the first embodiment of the present invention is a treatment liquid used for an object to be treated, which contains an Si—Ge-containing substance and an Si-containing substance, to remove at least a part of the Si—Ge-containing substance, the treatment liquid containing a fluoride ion source, an organic acid, an oxidant, a solvent having a relative permittivity of 10 or less, and water, in which a content of the water is more than 0% by mass and less than 30% by mass with respect to the total mass of the treatment liquid.

Hereinafter, components contained in the treatment liquid according to the first embodiment and components which may be contained in the treatment liquid will be described.

### Fluoride Ion Source

The treatment liquid according to the first embodiment of the present invention contains a fluoride ion source.

The fluoride ion source is a compound capable of releasing a fluoride ion or a fluorine-containing ion in the treatment liquid. In the treatment liquid according to the first embodiment, the fluoride ion source may be in a form of the fluoride ion or the fluorine-containing ion.

Examples of the fluorine-containing ion include a bifuloride ion (HF₂⁻), SiF₆²⁻, TiF₆²⁻, ZrF₆²⁻, PF₆⁻, and BF₄⁻.

The fluoride ion source is usually a salt of a fluoride ion or a fluorine-containing ion and a cation.

Examples of the cation preferably contained in the fluoride ion source include H⁺, Li⁺, Na⁺, K⁺, and NH₄⁺; and H⁺is preferable.

As the fluoride ion source, hydrogen fluoride (HF), ammonium fluoride (NH₄F), hexafluorosilicic acid (H₂SiF₆), hexafluorosilicic acid (Na₂SiF₆), hexafluorosilicic acid (H₂TiF₆), hexafluorozirconic acid (H₂ZrF₆), hexafluorophosphoric acid (HPF₆), or hexafluorophosphoric acid (HBF₄) is preferable; hydrogen fluoride or ammonium fluoride is more preferable; and hydrogen fluoride is still more preferable.

From the viewpoint that the Si—Ge dissolution selectivity is more excellent, a content of the fluoride ion source is preferably 0.001% to 20.0% by mass, more preferably 0.01% to 10.0% by mass, still more preferably 0.05% to 5.0% by mass, and particularly preferably 0.1% to 1.0% by mass with respect to the total mass of the treatment liquid.

The fluoride ion source may be used alone or in combination of two or more kinds thereof. In a case where two or more kinds of the fluoride ion sources are used, the total amount thereof is preferably within the above-described preferred content range.

As the fluoride ion source, a solution containing a fluoride ion source may be used. In a case where a solution containing a fluoride ion source is used as the fluoride ion source, the content of the fluoride ion source is a content of the fluoride ion source contained in the solution.

### Organic Acid

The treatment liquid according to the first embodiment of the present invention contains an organic acid.

In the treatment liquid, the organic acid may react with the oxidant to form a peracid.

Examples of the organic acid include an organic phosphoric acid having a phosphoric acid group in the molecule, an organic sulfonic acid having a sulfo group in the molecule, and a carboxylic acid having a carboxy group in the molecule; and a carboxylic acid is preferable. The number of carbon atoms in the organic acid is preferably 1 to 8, more preferably 1 to 6, and still more preferably 1 to 4.

Examples of the carboxylic acid include formic acid, acetic acid, propionic acid, butyric acid, valeric acid, benzoic acid, oxalic acid, succinic acid, glutaric acid, phthalic acid, lactic acid, malic acid, tartaric acid, citric acid, and gluconic acid; and formic acid, acetic acid, propionic acid, or butyric acid is preferable.

From the viewpoint that the Si—Ge dissolution selectivity is more excellent, a content of the organic acid is preferably 10.0% to 95.0% by mass, more preferably 30.0% to 90.0% by mass, and still more preferably 50.0% to 80.0% by mass with respect to the total mass of the treatment liquid.

The organic acid may be used alone or in combination of two or more kinds thereof. In a case where two or more kinds of the organic acids are used, the total amount thereof is preferably within the above-described preferred content range.

As the organic acid, a solution containing an organic acid may be used. In a case where a solution containing an organic acid is used as the organic acid, the content of the organic acid is a content of the organic acid contained in the solution.

### Oxidant

The treatment liquid according to the first embodiment of the present invention contains an oxidant.

The oxidant is not particularly limited as long as it has oxidation ability, and examples thereof include hydrogen peroxide, nitric acid, cerium nitrate, iron nitrate, performic acid, peracetic acid, perpropionic acid, periodic acid, periodate, perchloric acid, perchlorate, chloric acid, hypochlorous acid, hypochlorite, persulfuric acid, persulfate, peroxodisulfuric acid, peroxodisulfate, isocyanuric acid, isocyanurate, trichloroisocyanuric acid, and trichloroisocyanurate. The above-described periodic acid includes metaperiodic acid (HIO₄) and orthoperiodic acid (H₅IO₆). In addition, the above-described periodate includes a metaperiodate and an orthoperiodate.

Among these, as the oxidant, hydrogen peroxide or peracetic acid is preferable, and hydrogen peroxide is more preferable.

From the viewpoint that the Si—Ge dissolution selectivity is more excellent, a content of the oxidant is preferably 0.1% to 20.0% by mass, more preferably 1.0% to 15.0% by mass, and still more preferably 2.0% to 10.0% by mass with respect to the total mass of the treatment liquid.

### Solvent Having Relative Permittivity of 10 or Less

The treatment liquid according to the first embodiment of the present invention contains a solvent having a relative permittivity of 10 or less.

However, the solvent having a relative permittivity of 10 or less is a compound different from the above-described organic acid, and a compound corresponding to the above-described organic acid is not included in the solvent having a relative permittivity of 10 or less.

In the present specification, a value measured by a capacitance measuring device is adopted as the relative permittivity. Specifically, in the present specification, the relative permittivity of the solvent is measured by using a capacitance meter CM113N manufactured by Yamamoto Electric Industrial Co., Ltd., and putting the solvent at room temperature (20° C. to 25° C.) into a dedicated cup-shaped electrode.

For a compound for which it is difficult to measure the relative permittivity by the above-described method, a literature value may be referred to. In a case of referring to the literature value, a value at room temperature (20° C. to 25° C.) is used as the value of the relative permittivity of the compound. In the present specification, in a case where a relative permittivity of a compound is indicated with a temperature at the same time, the relative permittivity at the temperature is defined as a value of the relative permittivity of the compound in the present specification.

From the viewpoint of excellent compatibility with other components, the relative permittivity of the solvent having a relative permittivity of 10 or less is preferably 2.0 or more, and more preferably 2.2 or more. In addition, the relative permittivity of the solvent having a relative permittivity of 10 or less is not particularly limited as long as it is 10.0 or less, but is preferably 9.0 or less and more preferably 8.0 or less.

An SP value of the solvent having a relative permittivity of 10 or less is preferably 17 MPa^{1/2} or more, and more preferably 18 MPa^{1/2} or more.

The SP value refers to Hansen solubility parameters, in which the unit thereof is MPa^{1/2} (MPa^{0.5}). In the present specification, the SP value refers to a value calculated by Equation(S) using “practical Hansen solubility parameters HSPiP 5th edition” (software version 5.1.03).

$${( SP value )}^{2} = {δ}_{d}^{2} + {δ}_{p}^{2} + {δ}_{h}^{2} \qquad Equation ( S )$$

In Equation(S), δ_{d} represents energy due to a dispersion force, δₚ represents energy due to a dipole-dipole interaction, and δₕ represents energy due to a hydrogen bond.

The upper limit of the SP value of the solvent having a relative permittivity of 10 or less is not particularly limited, but is usually 50 MPa^{1/2} or less.

It is preferable that the solvent having a relative permittivity of 10 or less includes one or more selected from the group consisting of benzyl benzoate, methyl benzoate, 1,2,4-trichlorobenzene, o-dichlorobenzene, bromobenzene, methyl formate, diethyl oxalate, ethyl propionate, ethyl benzoate, dioxane, chlorobenzene, ethyl formate, tetrahydrofuran, phenetole, methyl acetate, ethyl bromide, benzene, m-xylene, toluene, ethyl acetate, methyl tetrahydrofuran, p-xylene, o-xylene, and pentyl acetate.

A content of the solvent having a relative permittivity of 10 or less is preferably 0.1% to 20.0% by mass, more preferably 1.0% to 15.0% by mass, and still more preferably 2.0% to 10.0% by mass with respect to the total mass of the treatment liquid.

In the treatment liquid, the number of kinds of the solvents having a relative permittivity of 10 or less may be one or two or more. In a case where two or more kinds of the solvents having a relative permittivity of 10 or less are used, the total amount thereof is preferably within the above-described preferred content range.

### Water

The treatment liquid according to the first embodiment of the present invention contains water, and the content of the water is more than 0% by mass and less than 30% by mass with respect to the total mass of the treatment liquid.

The water contained in the treatment liquid is not particularly limited, but from the viewpoint of not affecting the treatment target, distilled water, deionized water, pure water, or ultrapure water is preferable, and pure water or ultrapure water is more preferable.

The content of the water is more than 0% by mass and less than 30% by mass with respect to the total mass of the treatment liquid, but from the viewpoint that the dissolution variation can be further suppressed, it is preferably 0.5% to 20.0% by mass, more preferably 1.0% to 15.0% by mass, and still more preferably 5.0% to 15.0% by mass.

In addition, from the viewpoint that the dissolution variation can be further suppressed, a mass ratio of the content of the water to the content of the solvent having a relative permittivity of 10 or less is preferably 0.50 to 10.00 and more preferably 1.00 to 5.00.

### Amine Compound

It is also preferable that the treatment liquid according to the first embodiment of the present invention contains an amine compound.

The amine compound refers to a compound in which one or more hydrogen atoms of ammonia are substituted with a hydrocarbon group which may have a substituent.

The amine compound is also preferably an alkanolamine compound including a hydrocarbon group (preferably, an alkyl group) having at least a hydroxy group as a substituent.

More specifically, the amine compound is preferably an amine compound represented by Formula (I).

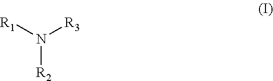

In Formula (I), R₁ represents an alkyl group having 1 to 8 carbon atoms, which may have at least one of a hydroxy group or a primary amino group. The alkyl group moiety of the R₁ may be linear or branched, or may have a cyclic structure. As the group represented by R₁, an alkyl group having 1 to 5 carbon atoms, which has a hydroxy group or a primary amino group, is preferable; and an alkyl group having 2 to 4 carbon atoms, which has a hydroxy group or a primary amino group, is more preferable. R₁ may have a plurality of hydroxy groups or primary amino groups.

In Formula (I), R₂ represents an alkyl group having 1 to 8 carbon atoms, which may have a hydroxy group, or a hydrogen atom. In a case where the R₂ represents an alkyl group having 1 to 8 carbon atoms, which may have a hydroxy group, the alkyl group moiety may be linear or branched, or may have a cyclic structure. As the group represented by R₂, an alkyl group having 1 to 5 carbon atoms, which has a hydroxy group, is preferable; and an alkyl group having 1 to 4 carbon atoms, which has a hydroxy group, is more preferable. R₂ may have a plurality of hydroxy groups.

In Formula (I), R₃ represents an alkyl group having 1 to 8 carbon atoms, which may have a hydroxy group. The alkyl group moiety of the R₃ may be linear or branched, or may have a cyclic structure. As the group represented by R₃, an alkyl group having 1 to 5 carbon atoms, which has a hydroxy group, is preferable; and an alkyl group having 1 to 4 carbon atoms, which has a hydroxy group, is more preferable. R₃ may have a plurality of hydroxy groups.

Examples of the amine compound represented by Formula (I) include diethanolamine, triethanolamine, N-methyldiethanolamine, N-ethyldiethanolamine, N-(3-aminopropyl)diethanolamine, and bis(2-hydroxyethyl)aminotris(hydroxymethyl)methane.

In a case where the treatment liquid contains an amine compound, a content of the amine compound is preferably 0.0001% to 1.0% by mass, more preferably 0.001% to 0.1% by mass, and still more preferably 0.005% to 0.05% by mass with respect to the total mass of the treatment liquid.

### Other Components

The treatment liquid according to the first embodiment of the present invention may contain other components in addition to the above-described components.

Hereinafter, the other components which may be contained in the treatment liquid will be described.

### Basic Compound

The treatment liquid may contain a basic compound.

The basic compound is a compound which exhibits alkalinity (a pH of more than 7.0) in an aqueous solution.

Examples of the basic compound include an organic base, an inorganic base, and a salt of these bases.

However, the basic compound is a compound different from the above-described amine compound.

Examples of the organic base include a quaternary ammonium salt, an amine oxide compound, a nitro compound, a nitroso compound, an oxime compound, a ketoxime compound, an aldoxime compound, a lactam compound, and an isocyanide compound.

Examples of the inorganic base include alkali metal hydroxides such as sodium hydroxide and potassium hydroxide, alkaline earth metal hydroxides, and ammonia or a salt thereof.

A content of the basic compound is not particularly limited, but is preferably 0.1% by mass or more and more preferably 0.5% by mass or more with respect to the total mass of the treatment liquid. The upper limit thereof is not particularly limited, but is preferably 20.0% by mass or less with respect to the total mass of the treatment liquid.

It is also preferable to adjust the content of the basic compound within the above-described suitable range so that a pH of the treatment liquid falls into a suitable range described later.

### Acidic Compound

The treatment liquid may contain an acidic compound.

The acidic compound is an acidic compound which exhibits acidity (a pH of less than 7.0) in an aqueous solution.

Examples of the acidic compound include an inorganic acid and a salt thereof.

However, the acidic compound is a compound different from the above-described fluoride ion source and oxidant.

Examples of the inorganic acid include sulfuric acid, phosphoric acid, nitric acid, and a salt thereof.

A content of the acidic compound is not particularly limited, but is preferably 0.1% by mass or more and more preferably 0.5% by mass or more with respect to the total mass of the treatment liquid. The upper limit thereof is not particularly limited, but is preferably 20.0% by mass or less with respect to the total mass of the treatment liquid.

It is also preferable to adjust the content of the acidic compound within the above-described suitable range so that a pH of the treatment liquid falls into a suitable range described later.

### Surfactant

The treatment liquid may contain a surfactant.

The surfactant is not particularly limited as long as it is a compound having a hydrophilic group and a hydrophobic group (lipophilic group) in one molecule, and examples thereof include an anionic surfactant, a cationic surfactant, and a nonionic surfactant.

However, the surfactant is a compound different from the above-described organic acid.

Examples of the hydrophobic group included in the surfactant include an aliphatic hydrocarbon group, an aromatic hydrocarbon group, and a combination thereof.

In a case where the hydrophobic group includes an aromatic hydrocarbon group, the number of carbon atoms in the hydrophobic group is preferably 6 or more and more preferably 10 or more.

In a case where the hydrophobic group does not include an aromatic hydrocarbon group and is composed of only an aliphatic hydrocarbon group, the number of carbon atoms in the hydrophobic group is preferably 8 or more and more preferably 10 or more. The upper limit of the number of carbon atoms in the hydrophobic group is not particularly limited, but is preferably 24 or less and more preferably 20 or less.

A content of the surfactant is not particularly limited, but is preferably 10 ppm by mass or more and more preferably 30 ppm by mass or more with respect to the total mass of the treatment liquid. The upper limit thereof is not particularly limited, but from the viewpoint of suppressing foaming of the treatment liquid, it is preferably 10% by mass or less and more preferably 5% by mass or less with respect to the total mass of the treatment liquid.

### Anticorrosion Agent

The treatment liquid may contain an anticorrosion agent.

The anticorrosion agent is added to the treatment liquid for the purpose of preventing etching of other materials present on the object to be treated, which will be described later.

However, the anticorrosion agent is a compound different from the above-described amine compound and surfactant.

The type of the anticorrosion agent is appropriately selected depending on the material type of the other materials present on the object to be treated.

Examples of the anticorrosion agent include an imine compound, a thiol compound, and a thioether compound. Among these, an imine compound is preferable, and a nitrogen-containing unsaturated heterocyclic compound is more preferable.

Examples of the nitrogen-containing unsaturated heterocyclic compound include pyridine, triazine, imidazole, benzimidazole, purine, xanthine, and a derivative thereof.

A content of the anticorrosion agent is not particularly limited, but is preferably 0.1% by mass or more and more preferably 1% by mass or more with respect to the total mass of the treatment liquid. The upper limit thereof is not particularly limited, but is preferably 10% by mass or less and more preferably 5% by mass or less with respect to the total mass of the treatment liquid.

### Insoluble Particles

It is preferable that the treatment liquid according to the embodiment of the present invention substantially does not contain insoluble particles.

The “insoluble particles” are particles of an inorganic solid, an organic solid, or the like, and correspond to particles which are present as particles without being finally dissolved in the treatment liquid.

The expression “does not substantially contain insoluble particles” means that the number of particles having a particle diameter of 50 nm or more, contained in 1 mL of a composition for measurement, is 40,000 or less in a case where the treatment liquid is diluted 10,000 times with the solvent contained in the treatment liquid to obtain the composition for measurement. The number of the particles contained in the composition for measurement can be measured in a liquid phase using a commercially available particle counter.

As a commercially available particle counter device, a device manufactured by RION Co., Ltd. or a device manufactured by PMS Co., Ltd. can be used. Representative examples of the device of the former include KS-19F, and representative examples of the device of the latter include Chem20. In order to measure larger particles, a device such as KS-42 series or LiQuilaz II S series can be used.

Examples of the insoluble particles include inorganic solids such as silica (including colloidal silica and fumed silica), alumina, zirconia, ceria, titania, germania, manganese oxide, and silicon carbide; and organic solids such as polystyrene, a polyacrylic resin, and polyvinyl chloride.

Examples of a method for removing the insoluble particles from the treatment liquid include a purification treatment such as filtering.

### Physical Properties of Treatment Liquid

### Coarse Particles

The treatment liquid may contain coarse particles, but it is preferable that a content thereof is low.

The coarse particles mean particles having a diameter (particle size) of 1 μm or more, in a case where a shape of the particles is regarded as a sphere. The particles included in the above-described insoluble particles may be included in the coarse particles.

A content of the coarse particles in the treatment liquid, in terms of content of particles having a particle size of 1 μm or more, is preferably 100 or less and more preferably 50 or less per 1 mL of the treatment liquid. A lower limit thereof is preferably 0 or more, and more preferably 0.01 or more per milliliter of the treatment liquid.

The coarse particles contained in the treatment liquid correspond to, for example, particles such as rubbish, dust, organic solid, and inorganic solid, which are contained as impurities in raw materials, and particles such as rubbish, dust, organic solid, and inorganic solid, which are brought in as contaminants during the preparation of the treatment liquid, in which those particles are finally present as particles without being dissolved in the treatment liquid.

The content of the coarse particles present in the treatment liquid can be measured in a liquid phase by using a commercially available measuring device in a light scattering type liquid particle measuring method using a laser as a light source.

Examples of a method for removing the coarse particles include a purification treatment such as filtering, which will be described later.

### Relative Permittivity of Treatment Liquid

A relative permittivity of the treatment liquid according to the first embodiment of the present invention is preferably 30 or less, more preferably 28 or less, and still more preferably 25 or less. The lower limit of the relative permittivity of the treatment liquid according to the first embodiment is not particularly limited, but is usually 5 or more.

The relative permittivity of the treatment liquid is a value obtained by calculating a value by multiplying a relative permittivity of a single substance of each component contained in the treatment liquid by a volume-based content proportion of each component, and summing the calculated values. A single substance of each component, having a volume-based content proportion of 0.1% by volume or less, is assumed to have a relative permittivity of 0. Details will be described in the section of the method for calculating the relative permittivity of the treatment liquid according to the second embodiment.

### pH

From the viewpoint that the Si—Ge dissolution selectivity is more excellent, a pH of the treatment liquid according to the first embodiment of the present invention is preferably 7.0 or less, and more preferably 4.0 or less. In addition, the pH of the treatment liquid is usually −1.0 or more.

The pH of the treatment liquid can be measured by a method based on JIS Z8802-1984 using a known pH meter. The measurement temperature is set to 25° C.

### Object to Be Treated

The treatment liquid according to the first embodiment of the present invention is used for the object to be treated, containing the Si—Ge-containing substance and the Si-containing substance.

The object to be treated is not particularly limited as long as it contains the Si—Ge-containing substance and the Si-containing substance, but in general, the Si—Ge-containing substance and the Si-containing substance are disposed on a substrate.

Here, the expression “on a substrate” includes any aspect of front and back surfaces, side surfaces, or inside of grooves of the substrate.

In addition, the “Si—Ge-containing substance and the Si-containing substance are disposed on a substrate” also includes a case where the Si—Ge-containing substance and the Si-containing substance are directly present on the surface of the substrate, and a case where the Si—Ge-containing substance and the Si-containing substance are present on the substrate through another layer.

In addition, the “Si—Ge-containing substance and Si-containing substance are disposed on the substrate” means that the presence form of the Si—Ge-containing substance and the Si-containing substance does not matter as long as the Si—Ge-containing substance and the Si-containing substance are simultaneously present on the substrate. For example, the Si—Ge-containing substance and the Si-containing substance may be in contact with each other or may be in contact with each other through another layer or member. In addition, there may be a form in which the Si—Ge-containing substance and the Si-containing substance are not in contact with each other, although the Si—Ge-containing substance and the Si-containing substance are present on the same substrate.

Among these, from the viewpoint that the effect of further suppressing the dissolution variation is easily exhibited, it is preferable that, in the object to be treated, the Si—Ge-containing substance and the Si-containing substance are in contact with each other in a case where the treatment liquid according to the embodiment of the present invention is applied.

The form of the Si—Ge-containing substance or the Si-containing substance on the substrate may be any form of film-like arrangement, wiring-like arrangement, plate-like arrangement, column-like arrangement, or particle-like arrangement.

It is preferable that the object to be treated is for manufacturing a semiconductor element. That is, the treatment liquid according to the first embodiment is preferably used in a step of manufacturing a semiconductor element.

Preferred examples of the element obtained by applying the treatment liquid to the object to be treated include a field effect transistor (FET), and more preferred examples thereof include a gate-all-around field effect transistor (GAA-FET). That is, the object to be treated is preferably an object obtained in a manufacturing process of the GAA-FET.

More specific aspects of the object to be treated and the treatment method using the treatment liquid will be described later.

In addition, the treatment liquid according to the first embodiment can also be used in a step of manufacturing a semiconductor element. For example, the object to be treated may contain a material composed of the Si—Ge-containing substance present on a substrate, an insulating film, a resist film, an antireflection film, an etching residue, an ashing residue, and the like. In addition, the object to be treated may be a substrate after chemical mechanical polishing.

The above-described substrate is not particularly limited, and examples thereof include a metal substrate, a semiconductor substrate, a conductive substrate other than the metal substrate, a metal oxide substrate, a glass substrate, and a resin substrate. Among these, a semiconductor substrate is preferable.

Examples of the semiconductor substrate include a semiconductor wafer, a glass substrate for a photo mask, a glass substrate for liquid crystal display, a glass substrate for plasma display, a substrate for field emission display (FED), a substrate for an optical disk, a substrate for a magnetic disk, and a substrate for a magneto-optical disk.

Examples of a material constituting the semiconductor substrate include silicon, germanium, a III-V group compound such as GaAs, and a combination thereof.

Examples of the use of the element obtained by treating the object to be treated include a dynamic random access memory (DRAM), a ferroelectric random access memory (FRAM: registered trademark), a magnetoresistive random access memory (MRAM), a phase change random access memory (PRAM), a logic circuit, and a processor.

The object to be treated may contain a layer and/or a structure as desired, in addition to the Si—Ge-containing substance and the Si-containing substance.

For example, one or more members selected from the group consisting of a metal wire, a gate electrode, a source electrode, a drain electrode, an insulating layer, a ferromagnetic layer, and a non-magnetic layer may be disposed on the substrate.

The substrate may include an exposed integrated circuit structure.

Examples of the integrated circuit structure include an interconnection mechanism such as a metal wire and a dielectric material. Examples of metals and alloys used for the interconnection mechanism include aluminum, a copper-aluminum alloy, copper, nickel, nickel silicide, cobalt, cobalt silicide, ruthenium, platinum, gold, titanium, tantalum, tungsten, titanium nitride, and tantalum nitride. The substrate may include one or more layers of materials selected from the group consisting of silicon oxide, silicon nitride, silicon carbide, and carbon-doped silicon oxide.

### Treatment Method of Object to be Treated

The treatment liquid according to the first embodiment of the present invention is used for the above-described object to be treated. Hereinafter, a treatment method of the object to be treated using the treatment liquid will be described.

As the treatment method of the object to be treated, the object to be treated and the treatment liquid may be brought into contact with each other. In a case where the object to be treated and the treatment liquid are brought into contact with each other, the Si—Ge-containing substance in the object to be treated is selectively removed (etched).

Examples of the method of bringing the object to be treated and the treatment liquid into contact with each other include a method of immersing the object to be treated in the treatment liquid placed in a tank, a method of spraying the treatment liquid onto the object to be treated, a method of flowing the treatment liquid onto the object to be treated, and a method of combining these methods; and a method of immersing the object to be treated in the treatment liquid is preferable.

Furthermore, in order to further increase a treatment speed with the treatment liquid, a mechanical stirring method may be used.

Examples of the mechanical stirring method include a method of circulating the treatment liquid on the object to be treated, a method of flowing or spraying the treatment liquid on the object to be treated, and a method of stirring the treatment liquid with ultrasonic wave or megasonic wave.

A treatment time of the treatment using the treatment liquid can be appropriately adjusted.

The treatment time (contact time between the treatment liquid and the object to be treated) is preferably 0.5 to 60 minutes and more preferably 1 to 20 minutes.

A temperature of the treatment liquid during the treatment is preferably 10° C. to 100° C. and more preferably 15° C. to 60° C.

Examples of the object to be treated include the above-described aspects, and the object to be treated is preferably an object to be treated obtained in the manufacturing process of the GAA-FET.

The GAA-FET refers to an FET having a structure in which a side surface portion of a channel between a drain and a source is covered with a gate over the entire circumference. Examples of the channel in the GAA-FET include an aspect in which the channel includes a nano-sized wire-like member. In the manufacturing of the GAA-FET, for example, a process of selectively removing the Si—Ge-containing substance from an object to be treated having a nanostructure is included, and the treatment liquid according to the first embodiment can be preferably used in the process.

More specifically, first, an Si—Ge layer and an Si layer are alternately deposited on a silicon wafer by heteroepitaxy. Hereinafter, the Si—Ge layer and the Si layer which are alternately laminated are also simply referred to as “Si—Ge layer-Si layer laminated film”.

Examples of a configuration of the Si—Ge layer-Si layer laminated film include a configuration in which an Si—Ge layer (Si:Ge=70:30 (atomic number ratio)) having a film thickness of 10 nm and an Si layer having a film thickness of 20 nm are alternately laminated.

Next, a hard mask of silicon oxide and a hard mask of silicon nitride are formed in this order on the Si—Ge layer-Si layer laminated film, the hard masks are processed into a desired shape, and the Si—Ge layer-Si layer laminated film is processed along the shape of the hard masks. The shape to be processed can be appropriately selected, and for example, the Si—Ge layer-Si layer laminated film can be processed into a fin shape. In the Si—Ge layer-Si layer laminated film after the processing, the Si—Ge layer and the Si layer are exposed in a cross section.

In a case where the silicon wafer on which the above-described structure body is formed is used as the object to be treated and treated with the treatment liquid according to the first embodiment, the Si—Ge layer is selectively etched, and a nanowire-like Si can be formed.

The treatment method of the object to be treated using the treatment liquid may include other steps in addition to the step of bringing the object to be treated and the treatment liquid into contact with each other.

Examples of the other steps include a step of forming each of one or more structures selected from the group consisting of a metal wire, a gate structure, a source structure, a drain structure, an insulating layer, a ferromagnetic layer, a non-magnetic layer, and the like (for example, layer formation, etching, chemical mechanical polishing, and modification); a step of forming resist, an exposure step, a removing step, a heat treatment step, a washing step, and an inspection step.

The treatment method of the object with the treatment liquid may be performed at any stage among the back-end process (BEOL: back end of the line), the middle process (MOL: middle of the line), and the front-end process (FEOL: front end of the line); and it is preferable that the present treatment method is performed in a front-end process or a middle process.

### Treatment Liquid (Second Embodiment)

The treatment liquid according to the second embodiment of the present invention is a treatment liquid used for an object to be treated, which contains an Si—Ge-containing substance and an Si-containing substance, to remove at least a part of the Si—Ge-containing substance, the treatment liquid containing a fluoride ion source, an organic acid, and an oxidant, in which a relative permittivity of the treatment liquid is 30.0 or less.

Here, the relative permittivity is a value obtained by calculating a value by multiplying a relative permittivity of a single substance of each component contained in the treatment liquid by a volume-based content proportion of each component, and summing the calculated values. A single substance of each component, having a volume-based content proportion of 0.1% by volume or less, is assumed to have a relative permittivity of 0.

For example, a relative permittivity of a treatment liquid having the following formulation is determined as follows.
Fluoride ion source (dielectric constant: E₁): X₁%
Oxidant (dielectric constant: E₂): X₂%
Solvent 1 (dielectric constant: E₃): X₃%
Solvent 2 (dielectric constant: E₄): X₄%
Surfactant (dielectric constant: E₅): X₅%

Here, a value of X₁+X₂+X₃+X₄+X₅ is 100%, and a value of X₅ is less than 0.1%. X₁ to X₅ represent a volume-based content proportion with respect to the entire treatment liquid.

The relative permittivity of the treatment liquid having the above-described formulation is determined by the following expression, assuming that X₅ is 0.

$$( Relative permittivity of treatment liquid ) = ( {E}_{1} {X}_{1} + {E}_{2} {X}_{2} + {E}_{3} {X}_{3} + {E}_{4} {X}_{4} ) / 100$$

The relative permittivity of the treatment liquid according to the second embodiment of the present invention is preferably 28 or less, and more preferably 25 or less. The lower limit of the relative permittivity of the treatment liquid according to the second embodiment is not particularly limited, but is usually 5 or more.

Hereinafter, components contained in the treatment liquid according to the second embodiment and components which may be contained in the treatment liquid will be described.

### Fluoride Ion Source

The treatment liquid according to the second embodiment of the present invention contains a fluoride ion source.

Since examples, preferred aspects, content, and the like of the fluoride ion source are the same as those of the treatment liquid according to the first embodiment, the description thereof will be omitted.

### Organic Acid

The treatment liquid according to the second embodiment of the present invention contains an organic acid.

Since examples, preferred aspects, content, and the like of the organic acid are the same as those of the treatment liquid according to the first embodiment, the description thereof will be omitted.

### Oxidant

The treatment liquid according to the second embodiment of the present invention contains an oxidant.

Since examples, preferred aspects, content, and the like of the oxidant are the same as those of the treatment liquid according to the first embodiment, the description thereof will be omitted.

### Solvent Having Relative Permittivity of 10 or Less

The treatment liquid according to the second embodiment of the present invention preferably contains a solvent having a relative permittivity of 10 or less.

Since examples, preferred aspects, content, and the like of the solvent having a relative permittivity of 10 or less are the same as those of the treatment liquid according to the first embodiment, the description thereof will be omitted.

### Water

The treatment liquid according to the second embodiment of the present invention preferably contains water, and a content of the water is preferably more than 0% by mass and less than 30% by mass with respect to the total mass of the treatment liquid.

Since examples, preferred aspects, content, and the like of the water are the same as those of the treatment liquid according to the first embodiment, the description thereof will be omitted.

### Amine Compound

It is also preferable that the treatment liquid according to the second embodiment of the present invention contains an amine compound.

Since examples, preferred aspects, content, and the like of the amine compound are the same as those of the treatment liquid according to the first embodiment, the description thereof will be omitted.

### Other Components

The treatment liquid according to the second embodiment of the present invention may contain other components in addition to the above-described components. Since examples, preferred aspects, content, and the like of the other components are the same as those of the treatment liquid according to the first embodiment, the description thereof will be omitted.

### Object to be Treated

The treatment liquid according to the second embodiment of the present invention is used for the object to be treated, containing the Si—Ge-containing substance and the Si-containing substance.

Since examples, preferred aspects, and the like of the object to be treated are the same as those of the object to be treated for which the treatment liquid according to the first embodiment is used, the description thereof will be omitted.

### Treatment Method of Object to be Treated

The treatment liquid according to the second embodiment of the present invention is used for the above-described object to be treated. As the treatment method of the object to be treated, the object to be treated and the treatment liquid may be brought into contact with each other. In a case where the object to be treated and the treatment liquid are brought into contact with each other, the Si—Ge-containing substance in the object to be treated is selectively removed (etched).

Since examples, preferred aspects, and the like of the treatment method of the object to be treated are the same as those of the treatment method using the treatment liquid according to the first embodiment, the description thereof will be omitted.

### Method for Producing Treatment Liquid

The treatment liquid according to the first embodiment of the present invention and the treatment liquid according to the second embodiment of the present invention can be produced by a known method. Hereinafter, a method for producing the treatment liquid according to the first embodiment of the present invention and the treatment liquid according to the second embodiment of the present invention will be described.

### Liquid Preparation Step

As a method of preparing the treatment liquid, for example, the treatment liquid can be produced by mixing each of the above-described components.

The order and/or timing of mixing the above-described components is not particularly limited, and examples thereof include a method in which the solvent having a relative permittivity of 10 or less, the water, the fluoride ion source, and the oxidant are sequentially charged into a container containing a purified organic acid (for example, acetic acid), and then the mixture is stirred and mixed. In addition, a pH adjuster may be added thereto to adjust the pH of the mixed solution, thereby preparing a liquid. In addition, in a case where the respective components are charged into the container, the respective components may be charged at once, or may be charged in a divided manner a plurality of times.

As a stirring device and a stirring method used for preparing the treatment liquid, a known device may be used as a stirrer or a disperser. Examples of the stirrer include an industrial mixer, a portable stirrer, a mechanical stirrer, and a magnetic stirrer. Examples of the disperser include an industrial disperser, a homogenizer, an ultrasonic disperser, and a beads mill.

The mixing of the components in the step of preparing the treatment liquid, a refining treatment described later, and storage of the produced treatment liquid are preferably performed at 40° C. or lower, and more preferably performed at 30° C. or lower. In addition, the lower limit thereof is preferably 5° C. or higher, and more preferably 10° C. or higher. By performing the preparation of the treatment liquid, the treatment, and/or the storage of the treatment liquid in the above-described temperature ranges, the performance can be stably maintained for a long period of time.

### Dilution Step

The above-described treatment liquid may be used as a treatment liquid (diluted treatment liquid) which is diluted after undergoing a dilution step of diluting the treatment liquid using a diluent.

The diluted treatment liquid is also an aspect of the treatment liquid according to the embodiment of the present invention as long as it satisfies the requirements of the present invention.

### Kit

In addition, the treatment liquid according to the first embodiment of the present invention and the treatment liquid according to the second embodiment of the present invention may be a kit in which the raw materials are divided into a plurality of parts. In a case where the treatment liquid is used as a kit, the treatment liquid may be mixed at a predetermined ratio at the time of use or before use.

Examples of a specific method of using the treatment liquid as a kit include an aspect in which a liquid composition containing the organic acid, the fluoride ion source, the water, and the oxidant is prepared as a first liquid, and a liquid composition containing the solvent having a relative permittivity of 10 or less is prepared as a second liquid.

### Filtration Step

The method for producing the treatment liquid may include a filtration step of filtering the treatment liquid in order to remove foreign substances, coarse particles, and the like from the treatment liquid.

Examples of the filtering method include a known filtration method, and filtering using a filter is preferable.

Examples of the filter used for the filtering include known filters used for filtering.

Examples of a material constituting the filter include a fluororesin such as polytetrafluoroethylene (PTFE), a polyamide resin such as nylon, and a polyolefin resin (including a high-density polyolefin resin and an ultra-high-molecular-weight polyolefin resin) such as polyethylene or polypropylene (PP); and a polyamide resin, PTFE, or polypropylene (including high-density polypropylene) is preferable.

In a case where a filter composed of the above-described material is used, foreign substances having high polarity, which are likely to cause defects, can be more effectively removed from the treatment liquid.

A critical surface tension of the filter is preferably 70 mN/m or more. The upper limit thereof is preferably 95 mN/m or less. Among these, the critical surface tension of the filter is more preferably 75 to 85 mN/m.

The value of the critical surface tension is a nominal value from the manufacturer.

In a case of using a filter having a critical surface tension within the above-described range, it is possible to more effectively remove the foreign substances having high polarity, which are likely to cause defects, from the treatment liquid.

A pore diameter of the filter is preferably 0.001 to 1.0 μm, more preferably 0.02 to 0.5 μm, and still more preferably 0.01 to 0.1 μm. In a case where the pore diameter of the filter is within the above-described range, it is possible to remove fine foreign substances from the treatment liquid while suppressing filter clogging.

The filter may be a combination of two or more types of filters.

Filtering using a first filter may be carried out once or twice or more.

In a case where the filtering is carried out twice or more by combining a first filter and a second filter different from the first filter, each filter may be the same or different from each other, and is preferably different from each other. It is preferable that the first filter and the second filter differ from each other in at least one of the pore diameter or the constituent material.

It is preferable that a pore diameter of a filter for the second and subsequent filtering is the same as or smaller than a pore diameter of a filter for the first filtering. In addition, first filters having different pore diameters may be combined within the above-described range of the pore diameters of the filters. With regard to the pore diameters, reference can be made to nominal values of filter manufacturers.

Examples of the filter include filters manufactured by Nippon Pall Co., Ltd., Advantec Toyo Roshi Kaisha, Ltd., Nihon Entegris G.K., and Kitz Micro Filter Corporation.

Specific examples of the filter include P-NYLON FILTER made of polyamide (pore diameter: 0.02 μm, critical surface tension: 77 mN/m, manufactured by Nippon Pall Co., Ltd.), PE CLEAN FILTER made of high-density polyethylene (pore diameter: 0.02 μm, manufactured by Nippon Pall Co., Ltd.), and PE CLEAN FILTER made of high-density polyethylene (pore diameter: 0.01 μm, manufactured by Nippon Pall Co., Ltd.).

Examples of the second filter include a filter formed of the same material as that of the first filter.

The pore diameter of the second filter may be the same as the pore diameter of the first filter.

In a case where the pore diameter of the second filter is smaller than the pore diameter of the first filter, a ratio of the pore diameter of the second filter to the pore diameter of the first filter (Pore diameter of second filter/Pore diameter of first filter) is preferably 0.01 to 0.99, more preferably 0.1 to 0.9, and still more preferably 0.3 to 0.9. In a case where the pore diameter of the second filter is within the above-described range, fine foreign substances mixed in the treatment liquid can be further removed.

For example, the filtering using the first filter may be performed on a mixed solution containing some of the components of the treatment liquid, the rest of the components may be mixed with the mixed solution to prepare the treatment liquid, and then the filtering using the second filter may be performed.

It is preferable that the filter to be used is subjected to a washing treatment before the filtering of the treatment liquid.

The washing treatment is preferably a washing treatment using a liquid, and more preferably a washing treatment using the treatment liquid and a liquid containing components contained in the treatment liquid.

A temperature of the treatment liquid during the filtering is preferably room temperature (25° C.) or lower, more preferably 23° C. or lower, and still more preferably 20° C. or lower. The lower limit thereof is preferably 0° C. or higher, more preferably 5° C. or higher, and still more preferably 10° C. or higher.

In a case of the above-described temperature, the amount of particle foreign substances and impurities contained in the treatment liquid is reduced, and thus the filtering can be performed more efficiently.

### Static Electricity Removal Step

The method for producing the treatment liquid may further include a static electricity removal step of removing static electricity from the treatment liquid.

### Container

For example, a known container can be used as the container for accommodating the treatment liquid.

The container is preferably a container for semiconductor applications, which has a high degree of internal cleanliness and has low elution of impurities.

Examples of the container include “CLEAN BOTTLE” series (manufactured by Aicello Chemical Co., Ltd.) and “PURE BOTTLE” (manufactured by Kodama Plastics Co., Ltd.). In addition, from the viewpoint of preventing the incorporation of impurities (contamination) into the raw materials and the treatment liquid, it is also preferable to use a multi-layer container in which an interior wall of the container has a six-layer structure consisting of six types of resins, or a multi-layer container in which an interior wall of the container has a seven-layer structure consisting of seven types of resins.

Examples of the multi-layer container include containers described in JP2015-123351A, the contents of which are incorporated herein by reference.

Examples of a material of the interior wall of the container include a first resin of at least one selected from the group consisting of a polyethylene resin, a polypropylene resin, and a polyethylene-polypropylene resin, a second resin different from the first resin, and a metal such as stainless steel, Hastelloy, Inconel, and Monel. In addition, it is preferable that the interior wall of the container is formed of or coated with the above-described materials.

The second resin is preferably a fluororesin (perfluororesin).

In a case where a fluororesin is used, elution of an oligomer of ethylene or propylene can be suppressed.

Examples of the above-described container include FluoroPure PFA composite drum (manufactured by Entegris, Inc.), and containers described on page 4 of JP1991-502677A (JP-H03-502677A), page 3 of WO2004/016526A, and pages 9 and 16 of WO99/046309A.

As the interior wall of the container, for example, quartz is also preferable in addition to the fluororesin.

It is preferable that the inside of the container is washed before the container is filled with the treatment liquid.

A liquid used for the washing can be appropriately selected depending on the application, and is preferably a liquid containing at least one of the treatment liquid or components added to the treatment liquid.

From the viewpoint of preventing changes in the components of the treatment liquid during storage, the inside of the container may be purged with an inert gas (for example, nitrogen or argon) having a purity of 99.99995% by volume or more. In particular, a gas with a low moisture content is preferable. In addition, transportation and storage of the container accommodating the treatment liquid may be carried out either at normal temperature or under temperature control. Among these, from the viewpoint of preventing deterioration, it is preferable to control the temperature in a range of −20° C. to 20° C.

### EXAMPLES

Hereinafter, the present invention will be described in more detail with reference to Examples.

The materials, the amounts of materials used, the proportions, the treatment details, the treatment procedure, and the like shown in Examples below may be modified as appropriate as long as the modifications do not depart from the spirit of the present invention. Therefore, the scope of the present invention should not be construed as being limited to Examples shown below.

### Preparation of Treatment Liquid

A solvent and each component were mixed with the content shown in Table 1 later to obtain a mixed solution, and then the mixed solution was sufficiently stirred with a stirrer, thereby obtaining a treatment liquid used in each of Examples and Comparative Examples. More specifically, each component was added and mixed in a 250 ml beaker containing a 1-inch stirrer coated with Teflon (registered trademark) to obtain a treatment liquid.

The content of each component in the treatment liquid in Table 1 is based on mass. In a case where an aqueous solution was used as the raw material, the content of water described in the latter part of the table includes the amount of water contained in the aqueous solution. In addition, in a case where an aqueous solution was used as the raw material, the content of each component described in the latter part of the table is a content excluding water.

The definition of the relative permittivity in the table and below is as described above.

Abbreviations described in Table 1 later are as follows.

### Fluoride Ion Source

HF: 48% by mass hydrofluoric acid (aqueous solution containing 48% by mass of hydrogen fluoride with respect to the total mass of the aqueous solution)

The relative permittivity of a single substance of hydrogen fluoride is 83.6.
NH₄F: ammonium fluoride (relative permittivity of single substance: 4.4)

### Oxidant

Hydrogen peroxide: 30% to 45% by mass of hydrogen peroxide water (aqueous solution containing 30% to 45% by mass of hydrogen peroxide with respect to the total mass of the aqueous solution)

The relative permittivity of a single substance of hydrogen peroxide is 84.2 at 0° C.

### Organic Acid

Acetic acid: glacial acetic acid (relative permittivity of single substance: 6.2)
Propionic acid: propionic acid (relative permittivity of single substance: 3.4)

### Solvent Having Relative Permittivity of 10 or Less

Ethyl acetate: ethyl acetate (relative permittivity of single substance: 6.0, SP value: 18.2 MPa^{1/2})
Toluene: toluene (relative permittivity of single substance: 2.4, SP value: 18.2 MPa^{1/2})
Propyl acetate: propyl acetate (relative permittivity of single substance: 6.0, SP value: 17.6 MPa^{1/2})
Methyl benzoate: methyl benzoate (relative permittivity of single substance: 6.6, SP value: 21.1 MPa^{1/2})
PGDA: propylene glycol diacetate (relative permittivity of single substance: 1.9, SP value: 19.1 MPa^{1/2})

### Water

Ultrapure water (relative permittivity of single substance: 88.2)

### Surfactant

TAKESAAF A-47Q (manufactured by TAKEMOTO OIL & FAT Co., Ltd.; surfactant having the following structure)

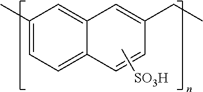

In the structural formula, n is 3 or 4.

### Amine Compound

APDA: N-(3-aminopropyl) diethanolamine

### Solvent Having Relative Permittivity of More Than 10

PG: propylene glycol (relative permittivity of single substance: 32.0)

### Evaluation

### Si—Ge Dissolution Selectivity

An Si substrate on which an Si—Ge film (Si:Ge=75:25 (atomic number ratio); corresponding to the Si—Ge-containing substance) was laminated to be a film thickness of 100 nm, and an Si substrate on which a polysilicon film (corresponding to a Si-containing substance) was laminated to be a film thickness of 100 nm on an oxide film having a film thickness of 100 nm were produced. Each of these substrates was cut into a 2×2 cm square to obtain a test piece.

Each test piece was immersed in a 1:100 diluted hydrofluoric acid solution for 1 minute, washed with water, blown with nitrogen gas, and dried. The test piece after the drying was immersed in the treatment liquid (22° C.) of Examples or Comparative Examples for 1 minute, rinsed with isopropyl alcohol (IPA) and rinsed with water, and dried by blowing nitrogen gas.

In each test piece, the film thickness before and after the immersion in the treatment liquid was measured with an optical film thickness meter (Ellipsometer M-2000 (manufactured by JA Woollam Co., Inc.)), and an amount of change in the film thickness of each test piece was calculated.

From the amount of change in the film thickness of each test piece, a dissolution rate (Å/min) of the Si—Ge film in a case of being brought into contact with the treatment liquid of Examples or Comparative Examples, and a dissolution rate (Å/min) of the polysilicon film were calculated. From the calculated dissolution rate of the Si—Ge film and the dissolution rate of the polysilicon film, an Si—Ge/Si dissolution selectivity ratio (dissolution rate of Si—Ge film/dissolution rate of polysilicon film) was calculated, and Si—Ge dissolution selectivity was evaluated based on the following standard.

As the Si—Ge dissolution selectivity ratio, a larger value indicates that the Si—Ge-containing substance was selectively dissolved with respect to the Si-containing substance; and in practical use, it is preferable to be evaluated as A or B.
A: Si—Ge/Si dissolution selectivity ratio was 10 or more.
B: Si—Ge/Si dissolution selectivity ratio was 5 or more and less than 10.
C: Si—Ge/Si dissolution selectivity ratio was less than 5.

### Si—Ge Surface Roughness

A surface roughness Ra of the surface of the Si—Ge film after immersing, in the treatment liquid of Examples, the test piece on which the Si—Ge film was formed by the above-described procedure was measured. The surface roughness Ra was measured using an atomic force microscope (AFM Dimension Icon, manufactured by Bruker Corporation). The measurement was performed in a tapping mode with a measurement range of 1 μm square.

The Si—Ge surface roughness was evaluated based on the following standard according to the obtained surface roughness Ra. In a case where the Si—Ge surface roughness was small, the Si—Ge-containing substance could be removed more uniformly, which is preferable.
A: surface roughness Ra was 0.30 nm or less.
B: surface roughness Ra was more than 0.30 nm and 1.00 nm or less.
C: surface roughness Ra was more than 1.00 nm.

### Evaluation of Rectangularity

An epi Si—Ge film (Si:Ge=75:25 (atomic number ratio), film thickness: 7 nm), an epi Si film (film thickness: 20 nm), an epi Si—Ge film (Si:Ge=75:25 (atomic number ratio), film thickness: 9 nm), an epi Si film (film thickness: 20 nm), an epi Si—Ge film (Si:Ge=75:25 (atomic number ratio), film thickness: 10 nm), an epi Si film (film thickness: 20 nm), an epi Si—Ge film (Si:Ge=75:25 (atomic number ratio), film thickness: 20 nm), and an epi Si film (film thickness: 20 nm) were sequentially formed on a substrate (silicon wafer). A line-and-space-shaped (line/space: 200 nm/500 nm) pattern was formed on the above-described films of the substrate on which the above-described films were formed, thereby obtaining a patterned substrate. In a side surface portion of the formed pattern, the epi Si—Ge film and the epi Si film were exposed. The “epi Si—Ge film” and the “epi Si film” refer to a film epitaxially grown on a film in direct contact with the film.

The obtained patterned substrate was cut into a 2×2 cm square to obtain a test piece.

The test piece was immersed in a diluted hydrofluoric acid obtained by diluting the hydrofluoric acid 100 times for 1 minute, washed with water, blown with nitrogen, and dried. The test piece after the drying was immersed in the treatment liquid (22° C.) of Examples or Comparative Examples for 1 minute, rinsed with IPA and rinsed with water, and dried by blowing nitrogen gas.

The test piece after the immersion was cut in a direction perpendicular to a direction in which lines of the above-described line-and-space pattern extended, and a cross section thereof was observed with a field emission scanning electron microscope (GEMINI 500 (manufactured by Carl Zeiss AG)). From the observed image of the cross section, a dissolution shape of the Si—Ge film having a film thickness of 20 nm was evaluated. Rectangularity was evaluated based on the following standard according to the dissolution shape of the Si—Ge film. A method of evaluating the rectangularity from the observed image of the cross section will be described later with reference to the drawings.

The rectangularity was evaluated as high in the order of A, B, and C; and as the evaluation is higher, the dissolution rate variation between the central portion and the end portion in the Si—Ge film (Si—Ge-containing substance) is more suppressed. In practical use, the evaluation A or the evaluation B is preferable, and the evaluation A is more preferable.
A: difference between the central portion and the end portion of the Si—Ge film was less than 2.5 nm.
B: difference between the central portion and the end portion of the Si—Ge film was 2.5 nm or more and less than 3.0 nm.
C: difference between the central portion and the end portion of the Si—Ge film was 3.0 nm or more and less than 3.5 nm.
D: difference between the central portion and the end portion of the Si—Ge film was 3.5 nm or more.

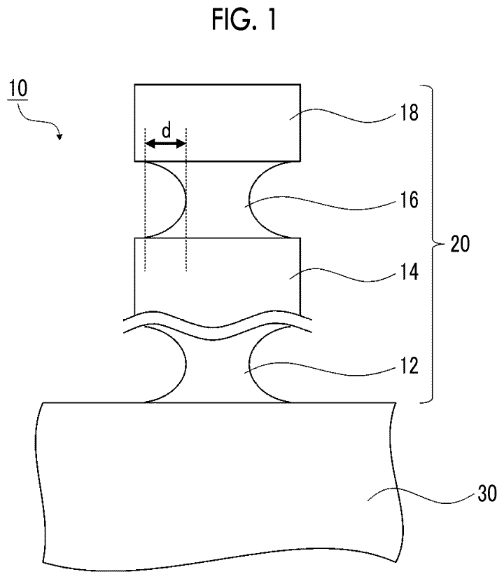

A method of evaluating the rectangularity from the observed image of the cross section will be described. FIG. 1 is a schematic view showing an example of the observed image of the cross section of the test piece. An observed image of a cross section of a test piece 10 shown in FIG. 1 shows an enlarged part of the observed image of the cross section in a direction perpendicular to the extending direction of a line portion 20 of the line-and-space pattern in the test piece. A part of the film included in the line portion 20 is not shown. The test piece 10 includes a substrate 30 and a line portion 20 disposed on the substrate 30, and the line portion 20 includes, in the following order from the substrate 30 side, a first Si—Ge film 12, a first Si film (not shown), a second Si—Ge film (not shown), a second Si film (not shown), a third Si—Ge film (not shown), a third Si film 14, a fourth Si—Ge film 16, and a fourth Si film 18.

Here, in the line portion 20, the fourth Si—Ge film 16 is brought into contact with the treatment liquid in the in-plane left-right direction of FIG. 1, and a part of the fourth Si—Ge film 16 is removed from the outside toward the inside, and the cross section thereof has an arc shape such that the inside of the fourth Si—Ge film 16 is convex. Here, the “central portion of the Si—Ge film” refers to a portion which is most recessed in the cross section of the fourth Si—Ge film 16 in FIG. 1, and the “end portion of the Si—Ge film” refers to a portion in contact with the third Si film 14 or a portion in contact with the fourth Si film 18. Therefore, the “difference between the central portion and the end portion of the Si—Ge film” corresponds to d in FIG. 1.

In a case where the positions of the portion of the fourth Si—Ge film 16 in contact with the third Si film 14 and the portion of the fourth Si film 18 in contact with the third Si film 14 in the left-right direction of FIG. 1 are different from each other, the position of the portion of the fourth Si—Ge film 16 in contact with the third Si film 14 and the position of the portion of the fourth Si—Ge film 16 in contact with the fourth Si film 18 having a larger difference between the central portion and the end portion is adopted.

In addition, in the above-described evaluation, the difference between the central portion and the end portion of the Si—Ge film was measured at 10 locations of the test piece, and the evaluation was performed based on the above-described standard according to an arithmetic mean thereof.

### Result

Table 1 shows the formulation of the treatment liquid of each of Examples and Comparative Examples, and the evaluation results in a case where the evaluation was carried out using the treatment liquid of each of Examples and Comparative Examples.

The content of each component shown in Table 1 is shown on a mass basis.

TABLE 1

| | Formulation | | | | | | | | | | |
|---|---|---|---|---|---|---|---|---|---|---|---|
| | | | | | | | | | | Solvent having | |
| | | | | | | | | | | relative | |
| | Fluoride | | | | | | | Amine | | permittivity | |
| | ion source | | Oxidant | | Organic acid | | Surfactant | compound | | of 10 or less | |
| | Type | Content | Type | Content | Type | Content | Content | Type | Content | Type | Content |
| Example 1 | HF | 0.30% | Hydrogen | 8.5% | Acetic | 70.00% | 0.01% | APDA | 0.01% | Ethyl | 4.2% |
| | | | peroxide | | acid | | | | | acetate | |
| Example 2 | HF | 0.30% | Hydrogen | 8.5% | Acetic | 70.00% | 0.01% | APDA | 0.01% | Toluene | 4.2% |
| | | | peroxide | | acid | | | | | | |
| Example 3 | HF | 0.30% | Hydrogen | 8.5% | Acetic | 70.00% | 0.01% | APDA | 0.01% | Propyl | 4.2% |
| | | | peroxide | | acid | | | | | acetate | |
| Example 4 | HF | 0.30% | Hydrogen | 8.5% | Acetic | 70.00% | 0.01% | APDA | 0.01% | Ethyl | 8.2% |
| | | | peroxide | | acid | | | | | acetate | |
| Example 5 | HF | 0.15% | Hydrogen | 8.5% | Acetic | 70.00% | 0.01% | APDA | 0.01% | Ethyl | 4.2% |
| | NH₄F | 0.15% | peroxide | | acid | | | | | acetate | |
| Example 6 | HF | 0.30% | Hydrogen | 8.5% | Propionic | 70.00% | 0.01% | APDA | 0.01% | Ethyl | 4.2% |
| | | | peroxide | | acid | | | | | acetate | |
| Example 7 | HF | 0.10% | Hydrogen | 8.5% | Acetic | 70.20% | 0.01% | APDA | 0.01% | Ethyl | 4.2% |
| | | | peroxide | | acid | | | | | acetate | |
| Example 8 | HF | 0.30% | Hydrogen | 5.0% | Acetic | 73.50% | 0.01% | APDA | 0.01% | Ethyl | 4.2% |
| | | | peroxide | | acid | | | | | acetate | |
| Example 9 | HF | 0.30% | Hydrogen | 8.5% | Acetic | 73.20% | 0.01% | APDA | 0.01% | Propyl | 1.0% |
| | | | peroxide | | acid | | | | | acetate | |
| Example 10 | HF | 0.30% | Hydrogen | 8.5% | Acetic | 69.20% | 0.01% | APDA | 0.01% | Ethyl | 2.5% |
| | | | peroxide | | acid | | | | | acetate | |
| | | | | | | | | | | Methyl | 2.5% |
| | | | | | | | | | | benzoate | |
| Example 11 | HF | 0.30% | Hydrogen | 8.5% | Acetic | 66.99% | 0.01% | — | — | Ethyl | 4.2% |
| | | | peroxide | | acid | | | | | acetate | |
| Example 12 | HF | 0.30% | Hydrogen | 8.5% | Acetic | 70.00% | 0.01% | APDA | 0.01% | PGDA | 4.2% |
| | | | peroxide | | acid | | | | | | |
| Comparative | HF | 0.30% | Hydrogen | 8.5% | Acetic | 45.00% | 0.01% | APDA | 0.01% | — | — |
| Example 1 | | | peroxide | | acid | | | | | | |
| Comparative | HF | 0.30% | Hydrogen | 8.5% | Acetic | 45.00% | 0.01% | APDA | 0.01% | — | — |
| Example 2 | | | peroxide | | acid | | | | | | |

| | Formulation | | | | | | |
|---|---|---|---|---|---|---|---|
| | Solvent having | | | | | | |
| | relative | | | | | | |
| | permittivity | | | Physical | Evaluation | | |
| | of more | | | properties | Si—Ge | Si—Ge | |
| | than 10 | | Water | Relative | dissolution | surface | |
| | Type | Content | Content | permittivity | selectivity | roughness | Rectangularity |
| Example 1 | — | — | 16.98% | 24.6 | A | A | B |
| Example 2 | — | — | 16.98% | 24.4 | A | A | B |
| Example 3 | — | — | 16.98% | 24.6 | A | B | B |
| Example 4 | — | — | 12.98% | 21.3 | A | A | A |
| Example 5 | — | — | 16.98% | 24.4 | A | A | B |
| Example 6 | — | — | 16.98% | 22.9 | A | A | B |
| Example 7 | — | — | 16.98% | 24.4 | A | A | B |
| Example 8 | — | — | 16.98% | 24.6 | A | A | B |
| Example 9 | — | — | 16.98% | 24.5 | A | B | B |
| Example 10 | — | — | 16.98% | 24.5 | A | A | B |
| | — | — | | | | | |
| Example 11 | — | — | 20.00% | 27.0 | B | A | B |
| Example 12 | — | — | 16.98% | 24.3 | A | A | B |
| Comparative | — | — | 46.18% | 48.6 | B | — | D |
| Example 1 | | | | | | | |
| Comparative | PG | 24.91% | 21.27% | 34.3 | A | — | C |
| Example 2 | | | | | | | |

From the results in Table 1, as in the treatment liquids of Comparative Examples 1 and 2, in a case where the solvent having a relative permittivity of 10 or less was not contained, the rectangularity was not excellent, and thus the dissolution variation could not be suppressed. In addition, as in the treatment liquids of Comparative Examples 1 and 2, in a case where the relative permittivity of the treatment liquid was more than 30, the rectangularity was not excellent, and thus the dissolution variation could not be suppressed.

On the other hand, it was found that the treatment liquids of Examples 1 to 12, containing the predetermined components in predetermined amounts, had excellent Si—Ge dissolution selectivity and excellent rectangularity, and thus can suppress the dissolution variation. In Example 12, the evaluation could be performed without any problem, but turbidity of the treatment liquid was observed.

From the comparison between Example 1 and Example 4, it was found that, in a case where the content of water was 1.0% to 15.0% by mass with respect to the total mass of the treatment liquid, the dissolution variation could be further suppressed.

From the comparison between Examples 1 and 2 and Example 3, it was found that, in a case where the SP value of the solvent having a relative permittivity of 10 or less was 18 MPa^{1/2} or more, the Si—Ge surface roughness was further suppressed.

### EXPLANATION OF REFERENCES

10: test piece

12: first Si—Ge film

14: third Si film

16: fourth Si—Ge film

18: third Si film

20: line portion

30: substrate

What is claimed is:

1. A treatment liquid used for an object to be treated, which contains a silicon-germanium-containing substance and a silicon-containing substance, to remove at least a part of the silicon-germanium-containing substance, the treatment liquid comprising:
a fluoride ion source;
an organic acid;
an oxidant;
a solvent having a relative permittivity of 10 or less; and
water,
wherein a content of the water is more than 0% by mass and less than 30% by mass with respect to a total mass of the treatment liquid.

2. A treatment liquid used for an object to be treated, which contains a silicon-germanium-containing substance and a silicon-containing substance, to remove at least a part of the silicon-germanium-containing substance, the treatment liquid comprising:
a fluoride ion source;
an organic acid; and
an oxidant,
wherein a relative permittivity of the treatment liquid is 30.0 or less,
where the relative permittivity is a value obtained by calculating a value by multiplying a relative permittivity of a single substance of each component contained in the treatment liquid by a volume-based content proportion of each component, and summing the calculated values, provided that a single substance of each component, having a volume-based content proportion of 0.1% by volume or less, is assumed to have a relative permittivity of 0.

3. The treatment liquid according to claim 2, further comprising:
a solvent having a relative permittivity of 10 or less; and
water,
wherein a content of the water is more than 0% by mass and less than 30% by mass with respect to a total mass of the treatment liquid.

4. The treatment liquid according to claim 1,
wherein the content of the water is 1.0% to 15.0% by mass with respect to the total mass of the treatment liquid.

5. The treatment liquid according to claim 1,
wherein a content of the solvent having a relative permittivity of 10 or less is 3.0% by mass or more with respect to the total mass of the treatment liquid.

6. The treatment liquid according to claim 1,
wherein a mass ratio of the content of the water to a content of the solvent having a relative permittivity of 10 or less is 1 to 10.

7. The treatment liquid according to claim 1,
wherein an SP value of the solvent having a relative permittivity of 10 or less is 18 MPa^{1/2} or more.

8. The treatment liquid according to claim 1,
wherein the solvent having a relative permittivity of 10 or less includes one or more selected from the group consisting of benzyl benzoate, methyl benzoate, 1,2,4-trichlorobenzene, o-dichlorobenzene, bromobenzene, methyl formate, diethyl oxalate, ethyl propionate, ethyl benzoate, dioxane, chlorobenzene, ethyl formate, tetrahydrofuran, phenetole, methyl acetate, ethyl bromide, benzene, m-xylene, toluene, ethyl acetate, methyl tetrahydrofuran, p-xylene, o-xylene, and pentyl acetate.

9. The treatment liquid according to claim 1,
wherein the treatment liquid contains two or more kinds of the solvents having a relative permittivity of 10 or less.

10. The treatment liquid according to claim 1,
wherein the organic acid includes one or more selected from the group consisting of formic acid, acetic acid, propionic acid, and butyric acid.

11. The treatment liquid according to claim 1, further comprising:
an amine compound represented by Formula (I), 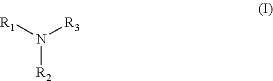
in Formula (I), R₁ represents an alkyl group having 1 to 8 carbon atoms, which may have at least one of a hydroxy group or a primary amino group,
in Formula (I), R₂ represents an alkyl group having 1 to 8 carbon atoms, which may have a hydroxy group, or a hydrogen atom, and
in Formula (I), R₃ represents an alkyl group having 1 to 8 carbon atoms, which may have a hydroxy group.

12. A treatment method comprising:
bringing an object to be treated, which contains a silicon-germanium-containing substance and a silicon-containing substance, into contact with the treatment liquid according to claim 1 to remove at least a part of the silicon-germanium-containing substance.

13. The treatment liquid according to claim 3,
wherein the content of the water is 1.0% to 15.0% by mass with respect to the total mass of the treatment liquid.

14. The treatment liquid according to claim 3,
wherein a content of the solvent having a relative permittivity of 10 or less is 3.0% by mass or more with respect to the total mass of the treatment liquid.

15. The treatment liquid according to claim 3,
wherein a mass ratio of the content of the water to a content of the solvent having a relative permittivity of 10 or less is 1 to 10.

16. The treatment liquid according to claim 3,
wherein an SP value of the solvent having a relative permittivity of 10 or less is 18 MPa^{1/2} or more.

17. The treatment liquid according to claim 3,
wherein the solvent having a relative permittivity of 10 or less includes one or more selected from the group consisting of benzyl benzoate, methyl benzoate, 1,2,4-trichlorobenzene, o-dichlorobenzene, bromobenzene, methyl formate, diethyl oxalate, ethyl propionate, ethyl benzoate, dioxane, chlorobenzene, ethyl formate, tetrahydrofuran, phenetole, methyl acetate, ethyl bromide, benzene, m-xylene, toluene, ethyl acetate, methyl tetrahydrofuran, p-xylene, o-xylene, and pentyl acetate.

18. The treatment liquid according to claim 3,
wherein the treatment liquid contains two or more kinds of the solvents having a relative permittivity of 10 or less.

19. The treatment liquid according to claim 2,
wherein the organic acid includes one or more selected from the group consisting of formic acid, acetic acid, propionic acid, and butyric acid.

20. The treatment liquid according to claim 2, further comprising:
an amine compound represented by Formula (I), 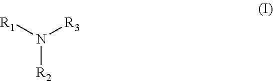
in Formula (I), R₁ represents an alkyl group having 1 to 8 carbon atoms, which may have at least one of a hydroxy group or a primary amino group,
in Formula (I), R₂ represents an alkyl group having 1 to 8 carbon atoms, which may have a hydroxy group, or a hydrogen atom, and
in Formula (I), R₃ represents an alkyl group having 1 to 8 carbon atoms, which may have a hydroxy group.
